(19) United States
(12) Patent Application Publication
(10) Pub. No.: US 2024/0257308 A1
(43) Pub. Date: Aug. 1, 2024

(54) IMAGE PROCESSING DEVICE AND ROBOT CONTROL DEVICE

(71) Applicant: FANUC CORPORATION, Yamanashi (JP)

(72) Inventor: Yuta NAMIKI, Yamanashi (JP)

(73) Assignee: FANUC CORPORATION, Yamanashi (JP)

(21) Appl. No.: 18/040,413

(22) PCT Filed: Aug. 4, 2021
(86) PCT No.: PCT/JP2021/028911

§ 371 Date: Feb. 2, 2023

(30) Foreign Application Priority Data
Aug. 11, 2020 (JP) 2020-135607

(51) Int. Cl. G06T 5/50; G06T 5/40; G06T 5/92; H04N 23/71; H04N 23/73

(52) U.S. Cl. CPC G06T 5/50; G06T 5/40; G06T 5/92; H04N 23/71; H04N 23/73; G06T 2207/20221

(57) ABSTRACT

Provided are an image processing device and a robot control device capable of determining an appropriate exposure time range and the number of imaging times for imaging a subject. An image processing device which processes a captured image of a subject comprises: a first exposure time determining unit which determines a minimum value of an exposure time for imaging the subject; a second exposure time determining unit which determines a maximum value of the exposure time for imaging the subject; an imaging condition determining unit which determines the exposure time for imaging the subject and the number of imaging times for imaging the subject; and a composite image generation unit that synthesizes a plurality of captured images of the subject using the determined exposure time and the number of imaging times to generate a composite image.

### TECHNICAL FIELD

The present invention relates to an image processing device and a robot control device.

### BACKGROUND ART

Typically, it is necessary for accurately performing a process such as workpiece handling or machining by means of a robot to accurately recognize the installation position of a workpiece and positional shift of the workpiece gripped by the robot. Thus, in recent years, the position of the workpiece and the positional shift of the workpiece are visually recognized using a visual sensor (see, e.g., Patent Document 1).
Patent Document 1: Japanese Unexamined Patent Application, Publication No. 2013-246149

### DISCLOSURE OF THE INVENTION

### Problems to be Solved by the Invention

When the visual sensor captures an image of an object (e.g., the workpiece), a brightness range cannot be properly represented only with one image in some cases. For example, if the brightness is adjusted according to a bright area within a field of view, a dark area is not visible due to blocked-up shadows. Conversely, if the brightness is adjusted according to the dark area within the field of view, the bright area is not visible due to blown-out highlights.

In order to cope with such a problem, a technique called high dynamic range (HDR) synthesis has been known. This technique combines a plurality of captured images, thereby generating a wide-dynamic-range image which cannot be obtained only with one image.

As it is time consuming to capture the plurality of images, it is preferable that the number of times of image-capture is low. For this reason, there has been a demand for a technique for properly determining an exposure time range for capturing an image of an object and the number of times of image-capture of the object.

### Means for Solving the Problems

An image processing device according to the present disclosure is an image processing device for processing a captured image of an object, the image processing device including a first exposure time determination unit that determines a minimum value of an exposure time for image-capture of the object, a second exposure time determination unit that determines a maximum value of the exposure time for image-capture of the object, an image-capture condition determination unit that determines the exposure time for image-capture of the object and the number of times of image-capture of the object based on an exposure time range including the determined minimum value of the exposure time and the determined maximum value of the exposure time, and a synthetic image generation unit that combines a plurality of object images, which have been captured with the determined exposure time and the determined number of times of image-capture, into a synthetic image.

A robot control device according to the present disclosure is a robot control device including an image processing device that processes a captured image of an object, the image processing device including a first exposure time determination unit that determines a minimum value of an exposure time for image-capture of the object, a second exposure time determination unit that determines a maximum value of the exposure time for image-capture of the object, an image-capture condition determination unit that determines the exposure time for image-capture of the object and the number of times of image-capture of the object based on an exposure time range including the determined minimum value of the exposure time and the determined maximum value of the exposure time, and a synthetic image generation unit that combines a plurality of object images, which have been captured with the determined exposure time and the determined number of times of image-capture, into a synthetic image.

An image processing device according to the present disclosure is an image processing device for processing a captured image of an object, the image processing device including a first exposure time determination unit that determines a minimum value of an optical parameter for image-capture of the object, a second exposure time determination unit that determines a maximum value of the optical parameter for image-capture of the object, an image-capture condition determination unit that determines the optical parameter for image-capture of the object and the number of times of image-capture of the object based on an optical parameter range including the determined minimum value of the optical parameter and the determined maximum value of the optical parameter, and a synthetic image generation unit that combines a plurality of object images, which have been captured with the determined optical parameter and the determined number of times of image-capture, into a synthetic image.

### Effects of the Invention

According to the present invention, the exposure time range for image-capture of the object and the number of times of image-capture of the object can be properly determined.

### BRIEF DESCRIPTION OF THE DRAWINGS

FIG. 1 is a view showing the configuration of a robot system;

FIG. 2 is a diagram showing the configuration of a robot control device;

FIG. 3 is a graph showing an acquirable brightness of an HDR synthetic image;

FIG. 4 is a graph showing a specific example of a blown-out highlight percentage and a blocked-up shadow percentage on a brightness histogram;

FIG. 5 is a flowchart showing the flow of processing of an image processing device;

FIG. 6 is a diagram schematically showing an example of an image processing system to which a plurality of visual sensors according to one embodiment of the present invention is connected; and

FIG. 7 is a diagram schematically showing an example of an image processing system to which a plurality of image processing devices according to one embodiment of the present invention is connected.

### PREFERRED MODE FOR CARRYING OUT THE INVENTION

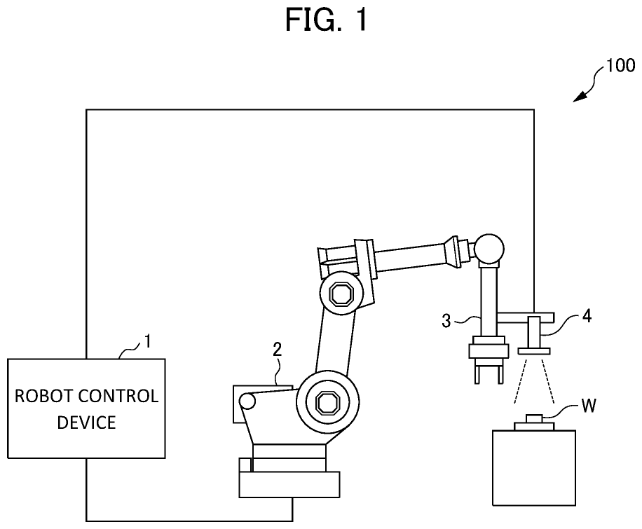

Hereinafter, an embodiment of the present invention will be described as an example. FIG. 1 is a view showing the configuration of a robot system 100. As shown in FIG. 1, the robot system 100 includes a robot control device 1, a robot 2, an arm 3, and a visual sensor 4.

A hand or a tool is attached to a tip end portion of the arm 3. The robot 2 performs a process such as handling or machining of a workpiece W by control by the robot control device 1. The visual sensor 4 is attached to the tip end portion of the arm 3 of the robot 2. Note that the visual sensor 4 is not necessarily attached to the robot 2, and for example, may be placed in a fixed manner at a predetermined position.

The visual sensor 4 images the workpiece W by control by the robot control device 1. As the visual sensor 4, a two-dimensional camera including an imaging element having a charge coupled device (CCD) image sensor and an optical system having a lens. For the visual sensor 4, an imaging element that can speed up image-capture according to a specified binning level of a captured image.

The robot control device 1 executes a robot program for the robot 2, thereby controlling movement of the robot 2. In such control, the robot control device 1 corrects, using the image captured by the visual sensor 4, movement of the robot 2 such that the robot 2 performs a predetermined process at the position of the workpiece W.

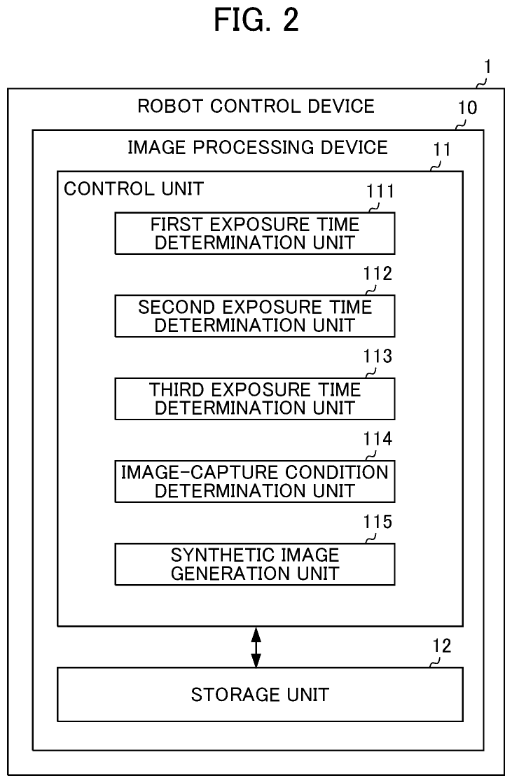

FIG. 2 is a diagram showing the configuration of the robot control device 1. The robot control device 1 includes an image processing device 10. Note that the robot control device 1 has a general configuration for controlling the robot 2, but description thereof will be omitted for the sake of simplicity in description. The image processing device 10 is a device that processes the image captured by the visual sensor 4. The image processing device 10 includes a control unit 11 and a storage unit 12.

The control unit 11 is a processor such as a central processing unit (CPU), and implements various functions by execution of programs stored in the storage unit 12.

The control unit 11 includes a first exposure time determination unit 111, a second exposure time determination unit 112, a third exposure time determination unit 113, an image-capture condition determination unit 114, and a synthetic image generation unit 115.

The storage unit 12 is a storage device such as a read only memory (ROM) or a random access memory (RAM) that stores an operating system (OS), an application program, etc. or a hard disk drive or a solid state drive (SSD) that stores various other types of information. The storage unit 12 stores, for example, various types of information such as the robot program.

The first exposure time determination unit 111 determines a minimum value of an exposure time for image-capture of an object (e.g., the workpiece W shown in FIG. 1). Specifically, the first exposure time determination unit 111 calculates the brightness of the object image captured with the minimum value of the exposure time, and changes the minimum value of the exposure time in a case where a value based on the calculated brightness is smaller than a first threshold H1. The first exposure time determination unit 111 repeats image-capture of the object, brightness calculation, and exposure time minimum value change until the value based on the brightness reaches the first threshold H1 or more, and determines the minimum value of the exposure time.

More specifically, the first exposure time determination unit 111 sets the minimum value of the exposure time for image-capture of the object in advance, and calculates a first histogram of the brightness of the object image captured with the minimum value of the exposure time.

Next, in a case where a greatest brightness value in the first histogram is smaller than the first threshold H1, the first exposure time determination unit 111 changes the minimum value of the exposure time such that the greatest brightness value approaches the first threshold H1. For example, the first exposure time determination unit 111 multiplies the minimum value of the exposure time by a predetermined numerical value, thereby changing the minimum value of the exposure time. The first threshold H1 is a value indicating that the greatest brightness value in the first histogram is sufficiently great.

The first exposure time determination unit 111 repeats image-capture of the object, first histogram calculation, and exposure time minimum value change until the greatest brightness value in the first histogram reaches the first threshold H1 or more, and determines the minimum value of the exposure time.

The second exposure time determination unit 112 determines a maximum value of the exposure time for image-capture of the object (e.g., the workpiece W shown in FIG. 1). Specifically, the second exposure time determination unit 112 calculates the brightness of an object image captured with the maximum value of the exposure time, and in a case where a value based on the calculated brightness is greater than a second threshold H2, changes the maximum value of the exposure time, repeats image-capture of the object, brightness acquisition, and exposure time maximum value change until the value based on the brightness reaches the second threshold H2 or less, and determines the maximum value of the exposure time.

More specifically, the second exposure time determination unit 112 sets the maximum value of the exposure time for image-capture of the object, and calculates a second histogram of the brightness of the object image captured with the maximum value of the exposure time.

Next, in a case where a smallest brightness value in the second histogram is greater than the second threshold H2, the second exposure time determination unit 112 changes the maximum value of the exposure time such that the smallest brightness value approaches the second threshold H2. For example, the second exposure time determination unit 112 multiplies the maximum value of the exposure time by a predetermined numerical value, thereby changing the maximum value of the exposure time. The second threshold H2 is a value indicating that the smallest brightness value in the second histogram is sufficiently small.

The second exposure time determination unit 112 repeats image-capture of the object, second histogram acquisition, and exposure time maximum value change until the smallest brightness value in the second histogram reaches the second threshold H2 or less, and determines the maximum value of the exposure time.

When setting the minimum value of the exposure time in advance, the first exposure time determination unit 111 uses a minimum value of an exposure time for an image captured in advance. When setting the maximum value of the exposure time in advance, the second exposure time determination unit uses a maximum value of an exposure time for an image captured in advance.

Specifically, the first exposure time determination unit 111 stores, in advance, a minimum value of an exposure time for an image captured in previous image-capture. When setting the minimum value of the exposure time in advance, the first exposure time determination unit 111 uses the minimum value of the exposure time for the image captured in previous image-capture.

Similarly, the second exposure time determination unit 112 stores, in advance, a maximum value of an exposure time for an image captured in previous image-capture. When setting the maximum value of the exposure time in advance, the second exposure time determination unit 112 uses the maximum value of the exposure time for the image captured in previous image-capture. With this configuration, the image processing device 10 can speed up measurement of the range of the exposure time.

When setting the minimum value of the exposure time in advance, the first exposure time determination unit 111 may use a minimum value of an exposure time for a captured image specified from an external source (e.g., a teaching operation board operated by an operator). When setting the maximum value of the exposure time in advance, the second exposure time determination unit 112 may use a maximum value of an exposure time for a captured image from an external source (e.g., a teaching operation board operated by an operator).

The third exposure time determination unit 113 calculates a reference histogram of the brightness of an object image captured with a reference exposure time between the minimum value of the exposure time and the maximum value of the exposure time, and stores the calculated reference histogram in the storage unit 12.

The third exposure time determination unit 113 calculates a third histogram of the brightness of the object image captured with the reference exposure time, and calculates an exposure time coefficient such that the third histogram is coincident with the reference histogram.

The image-capture condition determination unit 114 determines the exposure time for image-capture of the object and the number of times of image-capture of the object based on an exposure time range including the determined minimum value of the exposure time and the determined maximum value of the exposure time.

For example, the image-capture condition determination unit 114 delimits, into proper predetermined intervals, the exposure time range including the determined minimum value of the exposure time and the determined maximum value of the exposure time, takes the delimited point as the exposure time, and takes the number of times of delimitation as the number of times of image-capture. In this manner, the image-capture condition determination unit 114 determines the exposure time and the number of times of image-capture.

For example, in a case where the image-capture condition determination unit 114 divides the exposure time range into five, i.e., determines the number of times of image-capture as five, the predetermined intervals include an interval A1, an interval A2, an interval A3, and an interval A4. The image-capture condition determination unit 114 delimits the exposure time range such that the interval A2 has a length twice as long as the interval A1, the interval A3 has a length four times as long as the interval A1, and the interval A4 has a length eight times as long as the interval A1. That is, the lengths of the interval A1, the interval A2, the interval A3, and the interval A4 are in a proportional relationship.

The image-capture condition determination unit 114 calculates the exposure time range based on the minimum value of the exposure time, the maximum value of the exposure time, and the exposure time coefficient.

Specifically, the image-capture condition determination unit 114 multiples the minimum value of the exposure time and the maximum value of the exposure time by the exposure time coefficient calculated by the third exposure time determination unit 113, thereby obtaining the minimum value of the exposure time and the maximum value of the exposure time in consideration of the reference exposure time. The image-capture condition determination unit 114 calculates the exposure time range including the obtained minimum value of the exposure time and the obtained maximum value of the exposure time. In this manner, the image processing device 10 can calculate the exposure time range in consideration of the reference histogram and the reference exposure time.

The captured image used for determining the exposure time is a reduced image. The image processing device 10 uses the reduced image so that the processing for determining the exposure time can be sped up as compared to the case of using a captured image with a normal size.

The synthetic image generation unit 115 combines a plurality of object images, which have been captured with the determined exposure time and the determined number of times of image-capture, into a synthetic image. In this manner, the image processing device 10 generates a high dynamic range (HDR) synthetic image.

Note that the first exposure time determination unit 111 may determine, instead of the maximum value or minimum value of the brightness as described above, the minimum value based on a 1st-percentile value in a descending order of the brightness, for example. The second exposure time determination unit 112 may determine, instead of the above-described histogram, the maximum value based on a 1st-percentile value in an ascending order of the brightness, for example.

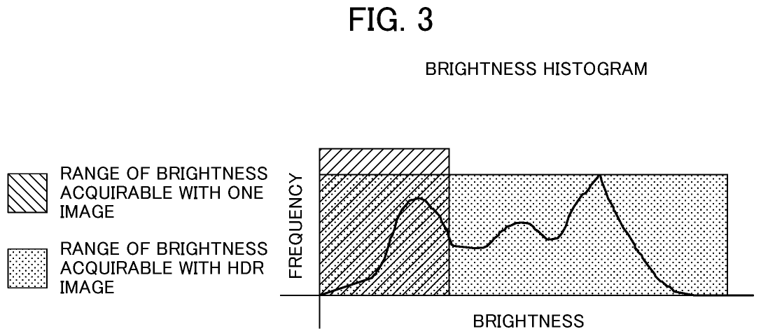

FIG. 3 is a graph showing an acquirable brightness of the HDR synthetic image. As shown in FIG. 3, the range of the acquirable brightness of the HDR synthetic image is broader than the range of an acquirable brightness of one captured image. Thus, the robot control device 1 can obtain a captured image with a high resolution.

The synthetic image generation unit 115 can specify at least one of a blown-out highlight percentage and a blocked-up shadow percentage for the plurality of captured images, and performs tone mapping for the synthetic image in a state in which pixels of the synthetic image corresponding to the blown-out highlight percentage are in white and pixels of the synthetic image corresponding to the blocked-up shadow percentage are in black.

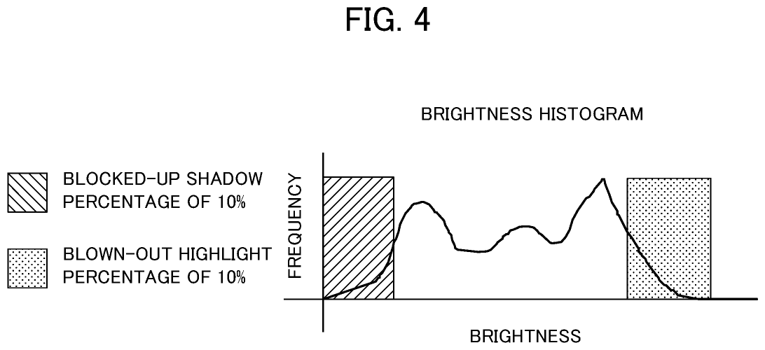

FIG. 4 is a graph showing a specific example of the blown-out highlight percentage and the blocked-up shadow percentage on the histogram of the brightness. As shown in FIG. 4, on the histogram of the brightness of the synthetic image, the synthetic image generation unit 115 blackens pixels in a 10% range in which the brightness is the smallest, and whitens pixels in a 10% range in which the brightness is the greatest.

The synthetic image generation unit 115 can also store the images before generation of the synthetic image. For example, the synthetic image generation unit 115 may save all the plurality of captured images, or may save the image before tone mapping. With this configuration, the image processing device 10 can adjust a parameter regarding image synthesis by means of the saved images when object detection or inspection with the synthetic image has failed. Moreover, the image processing device 10 can also automatically attempt another parameter adjustment method, thereby preventing system stop.

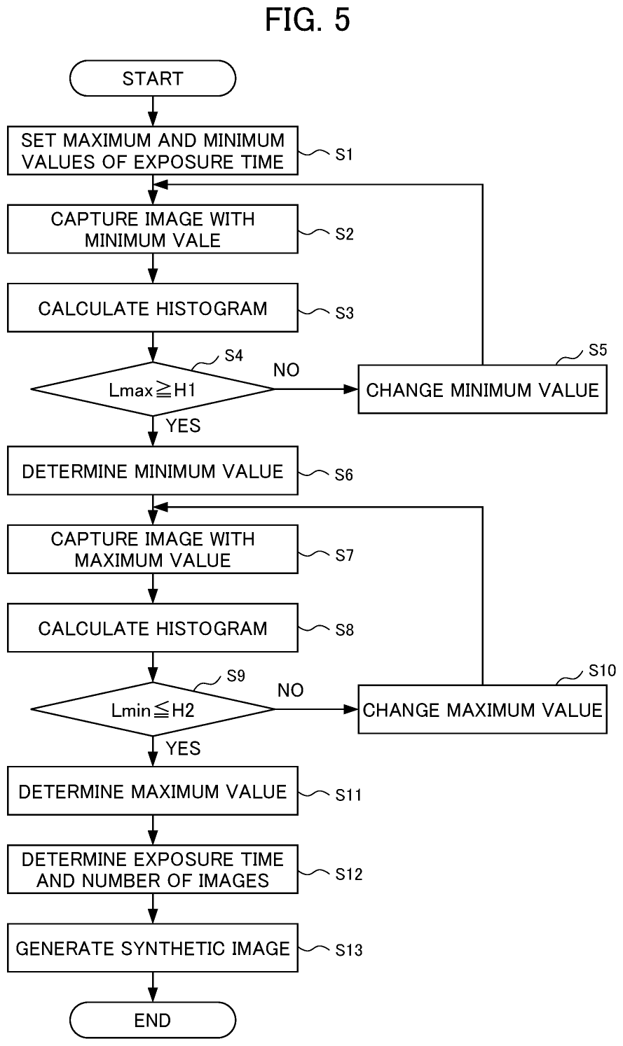

FIG. 5 is a flowchart showing the flow of the processing of the image processing device 10. In Step S1, the first exposure time determination unit 111 sets the minimum value of the exposure time for image-capture of the object in advance, and the second exposure time determination unit 112 sets the maximum value of the exposure time for image-capture of the object.

In Step S2, the visual sensor 4 images the object with the preset minimum value of the exposure time. In Step S3, the first exposure time determination unit 111 calculates the first histogram of the brightness of the object image captured with the minimum value of exposure time.

In Step S4, the first exposure time determination unit 111 determines whether or not the greatest brightness value Lmax in the first histogram calculated in Step S3 is equal to the first threshold H1 or more. In a case where Lmax is equal to the first threshold H1 or more (YES), the processing proceeds to Step S6. In a case where Lmax is less than the first threshold H1 (NO), the processing proceeds to Step S5.

In Step S5, the first exposure time determination unit 111 changes the minimum value of the exposure time such that the greatest brightness value approaches the first threshold H1.

In Step S6, the first exposure time determination unit 111 repeats the processing of Step S2 to Step S5, thereby determining the minimum value of the exposure time.

In Step S7, the visual sensor 4 images the object with the preset maximum value of the exposure time. In Step S8, the second exposure time determination unit 112 calculates the second histogram of the brightness of the object image captured with the maximum value of the exposure time.

In Step S9, the second exposure time determination unit 112 determines whether or not the smallest brightness value Imin in the second histogram calculated in Step S8 is equal to the second threshold H2 or less. In a case where Lmin is equal to the second threshold H2 or less (YES), the processing proceeds to Step S11. In a case where Lmin exceeds the second threshold H2 (NO), the processing proceeds to Step S10.

In Step S10, the second exposure time determination unit 112 changes the maximum value of the exposure time such that the smallest brightness value approaches the second threshold H2.

In Step S11, the second exposure time determination unit 112 repeats the processing of Step S7 to Step S10, thereby determining the maximum value of the exposure time.

In Step S12, the image-capture condition determination unit 114 determines the exposure time for image-capture of the object and the number of times of image-capture of the object based on the exposure time range including the minimum value of the exposure time determined in Step S6 and the maximum value of the exposure time determined in Step S11.

In Step S13, the synthetic image generation unit 115 combines the plurality of object images, which have been captured with the exposure time determined in Step S12 and the number of times of image-capture determined in Step S12, into the synthetic image.

As described above, according to the present embodiment, the image processing device 10 includes the first exposure time determination unit 111 that determines the minimum value of the exposure time for image-capture of the object, the second exposure time determination unit 112 that determines the maximum value of the exposure time for image-capture of the object, the image-capture condition determination unit 114 that determines the exposure time for image-capture of the object and the number of times of image-capture of the object based on the exposure time range including the determined minimum value of the exposure time and the determined maximum value of the exposure time, and the synthetic image generation unit that combines the plurality of object images, which have been captured with the determined exposure time and the determined number of times of image-capture, into the synthetic image.

With this configuration, the image processing device 10 can determine, without a photometric sensor, etc., the exposure time range and the number of times of image-capture appropriate for image-capture of the object, and can obtain the synthetic image.

The first exposure time determination unit 111 calculates the brightness of the object image captured with the minimum value of the exposure time, and changes the minimum value of the exposure time in a case where the value based on the calculated brightness is smaller than the first threshold H1. The first exposure time determination unit 111 repeats image-capture of the object, brightness calculation, and exposure time minimum value change until the value based on the brightness reaches the first threshold H1 or more, and determines the minimum value of the exposure time. With this configuration, the image processing device 10 can properly determine the minimum value of the exposure time.

The second exposure time determination unit 112 calculates the brightness of the object image captured with the maximum value of the exposure time, and changes the maximum value of the exposure time in a case where the value based on the calculated brightness is greater than the second threshold H2. The second exposure time determination unit 112 repeats image-capture of the object, brightness acquisition, and exposure time maximum value change until the value based on the brightness reaches the second threshold or less, and determines the maximum value of the exposure time. With this configuration, the image processing device 10 can properly determine the maximum value of the exposure time.

The captured image used for determining the exposure time is the reduced image. With this configuration, the image processing device 10 can speed up, by use of the reduced image, the processing for determining the exposure time as compared to the case of using the captured image with the normal size.

The first exposure time determination unit 111 uses the minimum value of the exposure time for the image captured in advance when setting the minimum value of the exposure time in advance. The second exposure time determination unit 112 uses the maximum value of the exposure time for the image captured in advance when setting the maximum value of the exposure time in advance. With this configuration, the image processing device 10 can speed up measurement of the exposure time range.

The first exposure time determination unit 111 uses the minimum value of the exposure time for the captured image specified from an external source when setting the minimum value of the exposure time in advance. The second exposure time determination unit 112 uses the maximum value of the exposure time for the captured image from an external source when setting the maximum value of the exposure time in advance. With this configuration, the image processing device 10 can speed up measurement of the exposure time range.

The third exposure time determination unit 113 calculates the reference histogram of the brightness of the object image captured with the reference exposure time between the minimum value of the exposure time and the maximum value of the exposure time, and stores the reference histogram in the storage unit 12. Next, the third exposure time determination unit 113 calculates the third histogram of the brightness of the object image captured with the reference exposure time, and calculates the exposure time coefficient such that the third histogram is coincident with the reference histogram.

The image-capture condition determination unit 114 calculates the exposure time range based on the minimum value of the exposure time, the maximum value of the exposure time, and the exposure time coefficient. With this configuration, the image processing device 10 can calculate the exposure time range in consideration of the reference histogram and the reference exposure time.

The synthetic image generation unit 115 can specify at least one of the blown-out highlight percentage or the blocked-up shadow percentage for the plurality of captured images, and performs tone mapping for the synthetic image in a state in which the pixels of the synthetic image corresponding to the blown-out highlight percentage are in white and the pixels of the synthetic image corresponding to the blocked-up shadow percentage are in black. With this configuration, the image processing device 10 can properly obtain the synthetic image with a high resolution.

The synthetic image generation unit 115 records information on the original image before generation of the synthetic image, thereby generating the synthetic image by the different synthesis method. With this configuration, the image processing device 10 can adjust the parameter regarding image synthesis by means of the saved images when target detection or inspection with the synthetic image has failed.

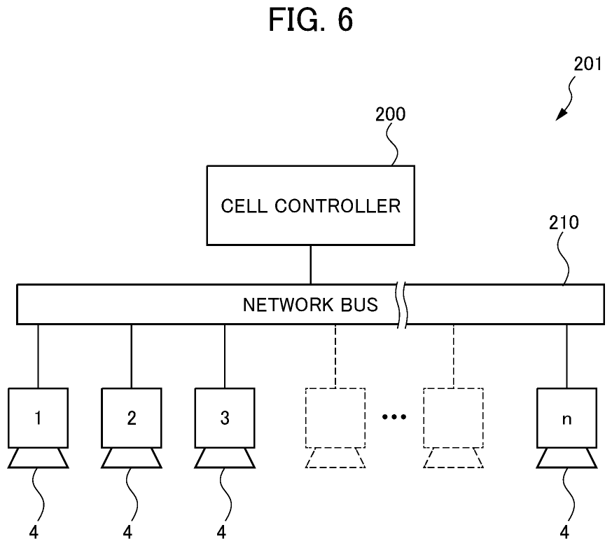

FIG. 6 is a diagram schematically showing an example of an image processing system 201 to which a plurality of visual sensors 4 according to one embodiment of the present invention is connected. In FIG. 6, N visual sensors 4 are connected to a cell controller 200 via a network bus 210. The cell controller 200 has a function similar to that of the above-described image processing device 10, and acquires a captured image from each of the N visual sensors 4.

In the image processing system 201 shown in FIG. 6, the cell controller 200 may have a machine learner (not shown), for example. The machine learner acquires a group of learning data stored in the cell controller 200, thereby performing supervised learning. In this example, learning can be sequentially performed online.

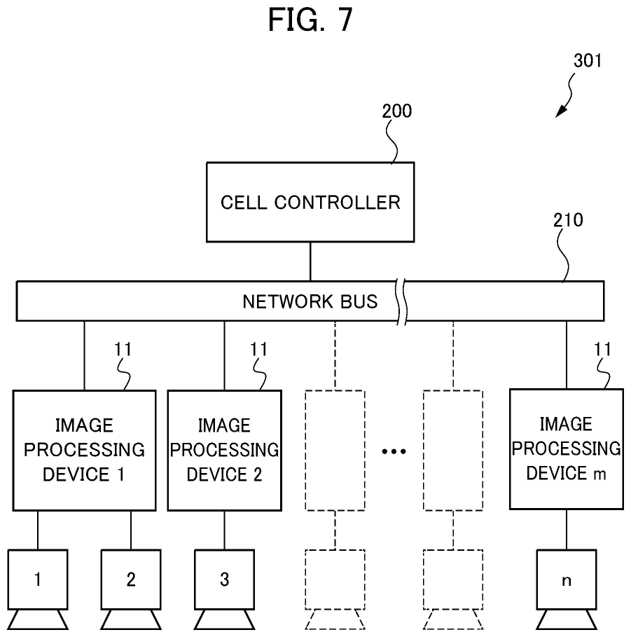

FIG. 7 is a diagram schematically showing an example of an image processing system 301 to which a plurality of image processing devices 10 according to one embodiment of the present invention is connected. In FIG. 7, m image processing devices 10 are connected to a cell controller 200 via a network bus 210. One or more visual sensors 4 are connected to each image processing device 10. The entirety of the image processing system 301 includes n visual sensors 4 in total.

In the image processing system 301 shown in FIG. 7, the cell controller 200 may have a machine learner (not shown), for example. The cell controller 200 may store, as a learning data set, a group of learning data sent from the plurality of image processing devices 10, and may build a learning model by machine learning. The learning model can be used in each image processing device 10.

Note that in the above-described embodiment, the image processing device 10 performs the control regarding the exposure time, but may perform control regarding an optical parameter other than the exposure time. For example, the image processing device 10 may perform control regarding an optical parameter such as an imaging element gain or a lens aperture, instead of the exposure time.

In this case, the image processing device 10 includes a first exposure time determination unit 111 that determines a minimum value of the optical parameter for image-capture of an object, a second exposure time determination unit 112 that determines a maximum value of the optical parameter for image-capture of the object, an image-capture condition determination unit 114 that determines the optical parameter for image-capture of the object and the number of times of image-capture of the object based on an optical parameter range including the determined minimum value of the optical parameter and the determined maximum value of the optical parameter, and a synthetic image generation unit that combines a plurality of object images, which have been captured with the determined optical parameter and the determined number of times of image-capture, into a synthetic image. With this configuration, the image processing device 10 can determine, without a photometric sensor, etc., the optical parameter range and the number of times of image-capture appropriate for image-capture of the object, and can obtain the synthetic image.

The embodiment of the present invention has been described above, and the robot control device 1 may be implemented by hardware, software, or a combination thereof. The control method performed by the robot control device 1 may also be implemented by hardware, software, or a combination thereof. Implementation by the software as described herein means implementation by reading and execution of a program by a computer.

The program can be stored using various types of non-transitory computer readable media and be supplied to the computer. The non-transitory computer readable media include various types of tangible storage media. Examples of the non-transitory computer readable media include magnetic recording media (e.g., a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a random access memory (RAM)).

Each embodiment described above is a preferable embodiment of the present invention, but the scope of the present invention is not limited only to each embodiment above and various changes can be made without departing from the gist of the present invention.

### EXPLANATION OF REFERENCE NUMERALS

1 Robot Control Device
2 Robot
3 Arm
4 Visual Sensor
10 Image Processing Device
11 Control Unit
12 Storage Unit
100 Robot System
111 First Exposure Time Determination Unit
112 Second Exposure Time Determination Unit
113 Third Exposure Time Determination Unit
114 Image-capture Condition Determination Unit
115 Synthetic Image Generation Unit

1. An image processing device for processing a captured image of an object, comprising:
a first exposure time determination unit that determines a minimum value of an exposure time for image-capture of the object;
a second exposure time determination unit that determines a maximum value of the exposure time for image-capture of the object;
an image-capture condition determination unit that determines the exposure time for image-capture of the object and the number of times of image-capture of the object based on an exposure time range including the determined minimum value of the exposure time and the determined maximum value of the exposure time; and
a synthetic image generation unit that combines a plurality of object images, which have been captured with the determined exposure time and the determined number of times of image-capture, into a synthetic image.

2. The image processing device according to claim 1, wherein the first exposure time determination unit
sets the minimum value of the exposure time for image-capture of the object in advance,
calculates a brightness of an object image captured with the minimum value of the exposure time, and changes the minimum value of the exposure time in a case where a value based on the calculated brightness is smaller than a first threshold, and
repeats image-capture of the object, brightness calculation, and exposure time minimum value change until the value based on the brightness reaches the first threshold or more, and determines the minimum value of the exposure time.

3. The image processing device according to claim 1, wherein the second exposure time determination unit
sets the maximum value of the exposure time for image-capture of the object in advance,
calculates a brightness of an object image captured with the maximum value of the exposure time, and changes the maximum value of the exposure time in a case where a value based on the calculated brightness is greater than a second threshold, and
repeats image-capture of the object, brightness acquisition, and exposure time maximum value change until the value based on the brightness reaches the second threshold or less, and determines the maximum value of the exposure time.

4. The image processing device according to claim 1, wherein the captured image used for determining the exposure time is a reduced image.

5. The image processing device according to claim 1, wherein
the first exposure time determination unit uses a minimum value of an exposure time for an image captured in advance when setting the minimum value of the exposure time in advance, and
the second exposure time determination unit uses a maximum value of an exposure time for an image captured in advance when setting the maximum value of the exposure time in advance.

6. The image processing device according to claim 1, wherein
the first exposure time determination unit uses a minimum value of an exposure time for a captured image specified from an external source when setting the minimum value of the exposure time in advance, and
the second exposure time determination unit uses a maximum value of an exposure time for a captured image from an external source when setting the maximum value of the exposure time in advance.

7. The image processing device according to claim 1, further comprising:
a third exposure time determination unit that calculates a reference histogram of a brightness of an object image captured with a reference exposure time between the minimum value of the exposure time and the maximum value of the exposure time, and stores the reference histogram in a storage unit, and calculates a third histogram of the brightness of the object image captured with the reference exposure time, and calculates an exposure time coefficient such that the third histogram is coincident with the reference histogram,
wherein the image-capture condition determination unit calculates the exposure time range based on the minimum value of the exposure time, the maximum value of the exposure time, and the exposure time coefficient.

8. The image processing device according to claim 1, wherein the synthetic image generation unit
is able to specify at least one of a blown-out highlight percentage or a blocked-up shadow percentage for the plurality of captured images, and
performs tone mapping for the synthetic image in a state in which a pixel of the synthetic image corresponding to the blown-out highlight percentage is in white and a pixel of the synthetic image corresponding to the blocked-up shadow percentage is in black.

9. The image processing device according to claim 1, wherein the synthetic image generation unit records information on an original image before generation of the synthetic image, thereby generating a synthetic image by a different synthesis method.

10. A robot control device including an image processing device that processes a captured image of an object, the image processing device comprising:
a first exposure time determination unit that determines a minimum value of an exposure time for image-capture of the object;
a second exposure time determination unit that determines a maximum value of the exposure time for image-capture of the object;
an image-capture condition determination unit that determines the exposure time for image-capture of the object and the number of times of image-capture of the object based on an exposure time range including the determined minimum value of the exposure time and the determined maximum value of the exposure time; and
a synthetic image generation unit that combines a plurality of object images, which have been captured with the determined exposure time and the determined number of times of image-capture, into a synthetic image.

11. An image processing device for processing a captured image of an object, comprising:
a first exposure time determination unit that determines a minimum value of an optical parameter for image-capture of the object;
a second exposure time determination unit that determines a maximum value of the optical parameter for image-capture of the object;
an image-capture condition determination unit that determines the optical parameter for image-capture of the object and the number of times of image-capture for the object based on an optical parameter range including the determined minimum value of the optical parameter and the determined maximum value of the optical parameter; and
a synthetic image generation unit that combines a plurality of object images, which have been captured with the determined optical parameter and the determined number of times of image-capture, into a synthetic image.
